(19) United States
(12) Patent Application Publication
(10) Pub. No.: US 2003/0233255 A1
(43) Pub. Date: Dec. 18, 2003

(54) METHOD OF COORDINATING MAINTENANCE OF VITAL PATIENT DATA AND SOFTWARE THEREFOR

(75) Inventor: ANDREW L. DIRIENZO, ELIZAVILLE, NY (US)

Correspondence Address: WESTERLUND & POWELL PC, 122 N ALFRED STREET, ALEXANDRIA, VA, 223143011

(73) Assignee: Raymond H.J. Powell

(21) Appl. No.: 09/444,507

(22) Filed: Nov. 22, 1999

Related U.S. Application Data
(60) Provisional application No. 60/109,453, filed on Nov. 23, 1998.

(51) Int. Cl. G06F 17/60

(52) U.S. Cl. 705/3

(57) ABSTRACT

The present invention provides a patient record including a digital vital patient record (VPR) storing essential predetermined information for a patient, and a hardcopy patient record (HCPR) storing routine information and essential information, wherein the information in the VPR takes precedence over corresponding information in the HCPR. Preferably, the HCPR is stored in a designated storage area, and a printout of the VPR is added to the HCPR each time the HCPR is retrieved from the storage area. Moreover, the HCPR is stored in a designated storage area, and the printout of the VPR corresponds to a request to retrieve the HCPR from the storage area. A method and corresponding software for maintaining the VPR are also described.

The present invention corresponds the invention is based on Provisional Patent Application No. 60/109,453, which was filed on Nov. 23, 1998, and which is incorporated, in its entirety, herein by reference.

### BACKGROUND OF THE INVENTION

1. Field of the Invention

The present invention relates to methodologies for gathering, archiving, and subsequent retrieving and updating of patient healthcare information. More specifically, the present invention relates to methods and corresponding software for creating a digital Vital Patient Record which automates much of the gathering, archiving, retrieving and updating functions mentioned above. A method of operating a Core Records System within the clinical environment is also disclosed.

2. Description of the Related Art

Healthcare delivery throughout most of the world depends on or is interlinked with patient healthcare records. Moreover, just within the clinical environment, there are many tasks related to this information, which tasks include:

(1) gathering healthcare data;

(2) archiving the healthcare data;

(3) accessing the healthcare data, e.g., in preparation for an office visit;

(4) exchanging healthcare data, e.g., between the primary care physician and a specialist; and

(5) updating the healthcare data, e.g., recording a prescribed medication and/or a diagnosis.

It will be appreciated that all of these tasks are labor intensive and time consuming. Moreover, these tasks are likely to be allocated to the lowest paid healthcare workers, who often are not familiar with the data they are tasked with maintaining. Hence, there are often inaccuracies in the healthcare data. It will also be appreciated that these errors in healthcare data often result in healthcare that is both costly and potentially dangerous. With respect to the former, it must be noted that 60% of the time, only 5% of the patient record is needed by the physician. With respect to the latter, patients may receive prescriptions for medicines that are incompatible with one another because, for example, the specialist is unaware of the medication prescribed by the primary care physician.

Primary care physicians and their staff keep a running record of their interactions with a patient, i.e., the patient record (PR), which record should contain all information related to the patient's health. The PR can be divided into the following two parts:

(1) Essential Information—This generally includes Demographic Information and the patient's Profile including: Current Medications; Family History; Chronic Problems; Surgeries; Allergies; and Hospitalizations; and

(2) Secondary Information—This generally includes: the results of diagnostic exams; the results of physical exams; the reason for the current visit to the physician's office; and the chronology regarding past office visits.

As previously mentioned, in a typical PR, the Essential Information constitutes only 5% of the total volume of data.

A typical clinical routine regarding the handling of the PR is as follows. The primary care physician typically has the hardcopy patient record (HCPR) present when a patient comes in for an office visit. The HCPR is an integral part of the normal clinical routine. During the examination, the doctor makes notations in the record. It should be mentioned here that doctors, for the most part, are wedded to their personal routine. This freedom is as old as the practice of medicine itself. It is sacrosanct. Changes are not just considered unnecessary nuisances but, rather, are viewed as unholy, vile, intrusions into the practice of medicine that must be resisted at all costs.

It will be appreciated that there are many other situations, beside the patient's office visit, which require that patient records be referred to and, possibly, amended. For example, the HCPR must be accessed when a specialist calls to obtain information about a patient's current medications In order to provide the requested patient data, the primary care physician's staff must pull the HCPR from the archives and review it. It should be mentioned that the staff should also amend the record to show what new medications, if any, the patient might be taking as a result of his/her visit to the specialist's office.

Moreover, the PR should be updated every time there is a change in patient information of any sort, e.g., change of address, change of health insurance provider, change in emergency contact information, etc. However, an ongoing problem with the current healthcare system is the maintenance of patient records. Many times the primary care physician, or his/her staff, does not update the patient record. There are many reasons for this:

(1) Updating the patient charts requires pulling the HCPR, which is both time consuming and costly;

(2) Updating of HCPRs is not easy within the hustle and bustle of the typical provider's office, i.e., the provider and his/her staff are overworked and easily distracted;

(3) Some healthcare workers lack training and/or experience suited to the task;

(4) There is no mechanism in place to assess the quality of the entries in the HCPR, i.e., even the physician reviewing the PR are generally not familiar with the needed information, they are only familiar with the expected information.

When patient records are not updated, or when patient records are not updated correctly, they are inaccurate. Inaccurate patent records are potentially dangerous. For example, at some future date, when yet another medication may be needed, the provider does not know all the current medications a patient may be taking. The physician, therefore, could inadvertently prescribe a medication that could result in a bad drug interaction.

It should be mentioned that in approximately 60% of the cases where the HCPR is pulled, it is done only to obtain the Essential Information. That is, the physician or his/her staff only needs the information contained in either the Patient Profile or the Demographic Information. The entire record, which is often one hundred pages long, is not needed. In other words, only 5% of the HCPR is needed 60% of the time.

There are four approaches to accessing, updating, and archiving patient information. These approaches contain serious deficiencies in terms of costs, accuracy, ease of use, and speed. Each of these approaches are discussed immediately below.

The four methods by which the healthcare worker can access, update and archive patient information are:

(1) Asking the patient—The information obtained by this approach is, at best, unreliable, since most patients, especially the elderly, cannot tell a doctor what medications they are taking. Moreover, this approach has the secondary effect that the hardcopy patient record doesn't get updated.

(2) Memory—This method is used by doctors who are called on weekends and evenings when there is no method for them to access the patient's record. It will be appreciated that reliance on memory amounts to an open invitation to malpractice litigation. Moreover, as with approach (1), the HCPR doesn't get updated.

(3) Hardcopy Patient Record—With this approach, the actual paper PR used by the physician in the examination room have to be pulled from archives and, after the physician has referred to and annotated the HCPR. It will be appreciated that handling of the HCPR is tedious, time consuming, costly, and often excessively slow process. The handling of HCPR is often worse the in large organizations, where the number of PRs have grown so large that the PR's are no longer within reach of the staff member charged with retrieving and reshelving the HCPRs. Studies have shown that, for a clinic with 50 doctors, it takes approximately 24 hrs to get the record; the average cost to retrieve and then refile a HCPR has been estimated at $8.00. It should be mentioned that because ofthe excessively long time associated with accessing the HCPR, the healthcare provider will often not use the HCPR, i.e., physician will have to go with what the patient tells him/her or will work from memory (approaches (1) and (2));

(4) Electronic Patient Record (ERP)—There are several companies that have developed software that allows a physician to create an electronic patient record. In this case, the entire patient record is a computer file. While an EPR would totally eliminate the need for the paper record, and, thereby, eliminate the cost and time associated with retrieving and subsequently replacing a HCPR, there are serious problems with this approach including:

(a) Cost—the software is very expensive, e.g., approximately $25,000 per provider;

(b) Complexity—the software is very difficult to learn and, after training, is merely difficult to use; and

(c) Consistency—the EPR is inconsistent with the normal clinical routine of most doctors.

These features of the ERP are an anathema to the majority of healthcare providers. As a result, the number of physicians who have adopted EPRs in their practice is small and growing slowly. Moreover, the currently available versions of the EPR are designed to do everything, but end up doing nothing because they aren't used. They constitute the brute force method, i.e., digitize everything.

What is needed is a method for handling essential patient information which is more reliable than a HCPR and less expensive to implement than an EPR system. Moreover, what is needed is a method of handling essential patient information which is simple to use, requires little training, and promotes quality management at all levels of the healthcare provider's office. What is also needed is software which assists the user in practicing the above-identified method.

### SUMMARY OF THE INVENTION

Based on the above and foregoing, it can be appreciated that there presently exists a need in the pertinent art which mitigates the above-described deficiencies.

In one aspect, the present invention provides a patient record including a digital vital patient record (VPR) storing essential predetermined information for a patient, and a hardcopy patient record (HCPR) storing routine information and essential information, wherein the information in the VPR takes precedence over corresponding information in the HCPR. Preferably, the HCPR is stored in a designated storage area, and a printout of the VPR is added to the HCPR each time the HCPR is retrieved from the storage area. Moreover, the HCPR is stored in a designated storage area, and the printout of the VPR corresponds to a request to retrieve the HCPR from the storage area.

In another aspect, the present invention provides a method of maintaining vital patient information complementing a hardcopy patient record (HCPR) maintained at a healthcare provider's office. Preferably, the method includes steps for generating a digital vital patient record (VPR) corresponding to a patient, updating predetermined information in at least one of N categories in the VPR, opening the VPR whenever the patient interacts with the healthcare provider's office, and inserting a printed copy of the VPR whenever the HCPR is accessed in the healthcare provider's office, wherein N is an integer greater than 1. Preferably, one of the N categories includes currently prescribed medications while another of the N categories is allergies. In an exemplary case, the method also includes executing a drug interaction screening program using the predetermined information in the currently prescribed medications category. In another exemplary case, the generating, updating, opening, and inserting steps are performed by a first user in the healthcare provider's office, and the method also includes a step of closing the VPR, the closing step being performed by a second user in the healthcare provider's office.

In yet another aspect, the present invention provides a recording medium for storing a computer readable instructions for converting a general purpose computer into a core records system for maintaining vital patient information complementing a hardcopy patient record (HCPR) maintained at a healthcare provider's office, wherein the instructions permit the computer to generate a digital vital patient record (VPR) corresponding to a patient, to update predetermined information in at least one of N categories in the VPR, to open and update the VPR whenever the patient interacts with the healthcare provider's office, and to print a copy of the VPR for insertion into the HCPR whenever the HCPR is accessed in the healthcare provider's office, wherein N is an integer greater than 1.

According to still another aspect, the present invention provides a computer program for converting a general purpose computer into a core records system for maintaining vital patient information complementing a hardcopy patient record (HCPR) maintained at a healthcare provider's office, wherein the instructions permit the computer to generate a digital vital patient record (VPR) corresponding to a patient, to update predetermined information in at least one of N categories in the VPR, to open and update the VPR whenever the patient interacts with the healthcare provider's office, and to print a copy of the VPR for insertion into the HCPR whenever the HCPR is accessed in the healthcare provider's office, wherein N is an integer greater than 1.

### BRIEF DESCRIPTION OF THE DRAWINGS

FIG. 1 is a high-level block diagram of a hyper-record according to the present invention;

FIG. 2 is a flowchart illustrating the steps for operating the Core Record (CR) System in order to maintain the Vital Patent Record (VPR) portion of the hyper-record;

FIG. 3 is a simulated screen capture of the opening screen of the CR System;

FIGS. 4(a) and 4(b) are simulated screen captures of newly-created and previously created VPRs, respectively;

FIG. 5 is a simulated screen capture of the Prescribe Medication Update Screen of the CR system;

FIG. 6 is a simulated screen capture of a VPR Encounter Log;

FIG. 7 a simulated screen capture of a Chronic Problem Update Screen;

FIG. 8 is a simulated screen capture of a Major Surgeries Update Screen;

FIG. 9 is a simulated screen capture of an Allergies Update Screen;

FIG. 10 is a simulated screen capture of a Family History Update Screen;

FIG. 11 is a simulated screen capture of a Comment Update Screen;

FIG. 12 is a simulated screen capture of a VPR Directory Screen; and

FIG. 13 is a simulated screen capture of a VPR Patient Log.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

As mentioned above, the present invention relates to a methodology for gathering, archiving, and subsequent retrieving and updating of patient healthcare information. In particular, the present invention relates to a Core Records (CR) System for creating a digital Vital Patient Record (VPR) which automates much of the aforementioned processes. Thus, a method of operating the Core Records System within the clinical environment to maintain and update the VPR advantageously will be described in greater detail below.

Before presenting a detailed discussion of the method and corresponding software according to the present invention, it would be beneficial to establish the terminology which will be used during the subsequent discussion. Although several of these terms have already been introduced, a consolidated lists will be useful to most readers.

| Abbre- | | |
|---|---|---|
| viation | Term | Discussion |
| CRS | Core Records (CR) | The CR system and corresponding soft- |
| | System (Software) | ware allows for the creation of a digital |
| | | Vital Patient Record (VPR). |
| EPR | Electronic Patient | An entire patient record stored as a |
| | Record | computer file. |
| E & M | Evaluation and | The VRP Patient Log gives the provider a |
| | Management | convenient way to document all the |
| | | encounters (services performed) |
| | | between his/her office and the patient |
| | | (or another healthcare worker acting for |
| | | the patient, e.g., a specialist). It |
| | | therefore is a fast, simple way for the |
| | | provider to comply with recent |
| | | government E & M regulations. |
| HCPR | Hard Copy Patient | A paper copy of the patient record file. |
| | Record | |
| VPR | Vital Patient Record | This is an electronic file which is designed |
| | | and specifically restricted to store |
| | | Essential Information. In contrast, each |
| | | of the EPR and the HCPR are designed to |
| | | contain all patient information, albeit |
| | | in different forms. It will be |
| | | appreciated that there will be one VPR for |
| | | each patient. It should be mentioned at this |
| | | point that the VPR is designed to facilitate |
| | | quick, simple, and cost effective accessing |
| | | and, if necessary, updating of essential |
| | | patient information. It should also be |
| | | mentioned that the VPR advantageously |
| | | can be interfaced with Practice |
| | | Management software, or other software |
| | | databases, to automatically enter |
| | | predetermined patient information. |
| — | VPR Dirrectory | The VPR Directory is a list of every VPR |
| | | in a provider's office. In most cases, |
| | | the VPR's will be listed alphabetically. |
| — | VPR Encounter File | The VPR Encounter File automatically |
| | | lists, in chronological order, every VPR |
| | | in a provider's office that has been |
| | | opened, when it was opened, who |
| | | accessed it, why it was accessed, and if |
| | | changes were made in it. It is |
| | | useful in determining a practice profile. |
| — | VPR Patient Log | The VPR Patient Log automatically |
| | | chronicles every time a particular |
| | | patient's VPR has been opened and |
| | | why it was opened. |

Before discussing the inventive method and corresponding software according to the present invention, it should be mentioned that data entry with respect to the VPR in the CR system employs a two step, overlay methodology. More specifically, changes are not made directly to the VPR itself. Instead, changes are first made on a computerized overlay sheet (or drop down box). This method allows for the essential information in the VPR to be displayed in an uncluttered format, while at the same time, it provides the convenience of having a check off list for data entry. In addition, this data entry methodology makes the installation of a two-tiered security system possible. For example, a VPR could be viewed by anyone on the staff, but data changes could only be made by those with proper security codes.

The basic method of operation according to the present invention will now be described. It should first be noted that one of the basic obstacles to overcome for the CR Systems concept is maintaining coherence between the VPR and the HCPR. The VPR is simple. In essence, the VPR contains only a subset, i.e., the Essential Information, of a patient record. In contrast, the HCPR is a complete patient record, i.e., it contains both the Essential Information and all other information. The danger, of course, is that the Essential Information, as portrayed in the following discussion, will be different from the information in the HCPR, i.e., the person only looking at one will be given a false impression of the current state of a patient's health.

The inventive method according to the present invention institutionalizes three basic principles, which principles are necessary to creating workable CR system. These three principles (rules) are as follows:

(1) Every time a patient record needs to be accessed, the digital VPR is opened and referred to first. From the discussion above, it will be appreciated that approximately 60% of the time, it will be unnecessary to resort to the HCPR. All changes to the patient essential information must be made directly to the VPR. It will be appreciate that the VPR is always current.

(2) In those cases where the HCPR is needed, the VPR for the patient must be printed out and placed as the top sheet of the HCPR, i.e., it will be the first thing that the provider sees. This brings the HCPR into harmony with the VPR, i.e., this automatically updates the HCPR. It will also be appreciated that the HCPR is only updated when it is actually used. It is updated by printing out the VPR and affixing this to the HCPR when it is pulled from the archives. There is no manual duplicate transcription of data from the VPR.

(3) All changes in essential patient information must be made in the VPR. It should be noted that this must be done regardless of whether these changes are made in the hardcopy patient record or not. This information will almost exclusively be simple, e.g., just a change in medication, and, therefore, is quick and easy to do. The staff is trained to review the patient's HCPR for this information as soon as the provider returns the HCPR to them after the patient's office visit.

Implementation of these three principles (rules) produce the following results:

(1) These rules are sufficient to guarantee that the CR system gives complete and consistent patient health information, even when applied in the clinical environment. These rules insure that the CR System can accomplish the goals of the invention and overcome the deficiencies of the prior art.

(2) The physician makes no changes in his/her normal clinical routine. His/her only requirement is to be alert to the fact that when he/she gets a HCPR, he/she is to verify that the latest, e.g., current, VPR be the top sheet. When he/she sees this, he/she knows that he/she has the complete Essential Information.

(3) The 60% of the time that the patient charts are referred to, the physician and his/her staff need only use the VPR. It will be appreciated that this provides the healthcare provider with the related and much needed savings in time, energy, and costs.

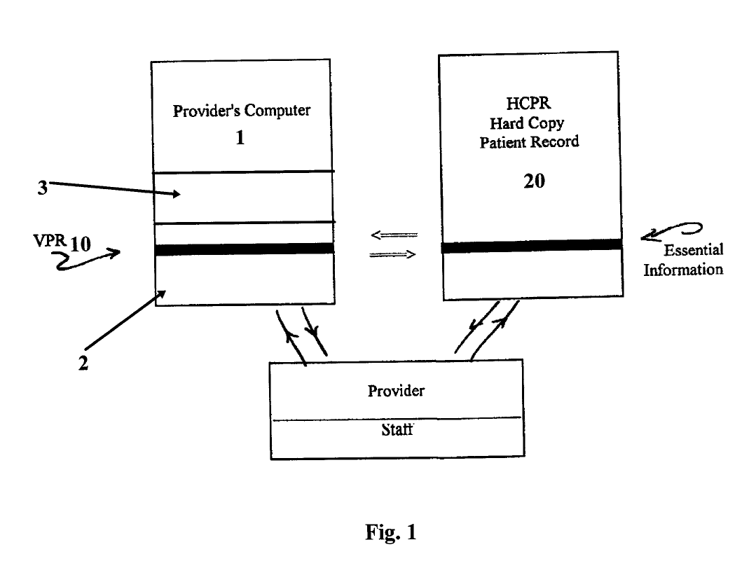

It will be appreciated that the method according to the present invention can be thought of as the HCPR plus the digital VPR plus the “Method of Operation.” Stated another way, these three parts advantageously can be considered to be three parts of a new concept, the “hyper-record,” which will be discussed in greater detail with respect to FIG. 1. It should be noted that the VPR does not replace the HCPR but, rather, the VPR augments and enhances the HCPR. It should also be noted that the total amount of information recorded by the healthcare provider's staff is the same amount of information that was available with the HCPR alone, although the usefulness of the HCPR has been dramatically increased while the number of errors has been drastically reduced. Alternatively, the invention can be accurately described as a method for access (extracting) essential patient information that is embedded in the full patient record.

It will be appreciated that the present invention takes advantage of the fact that approximately 60% of the time, only 5 % of the total patient recorded is needed by the healthcare provider to support the patient. In other words, 60% of the time the VPR is all that is needed by the healthcare provider. From another perspective, it is implicit from the above statement that at least 60% of the potential savings associated with a fill EPR is derived from approximately 5% of the digitized information. Therefore, the invention just digitizes the essential 5% of the patient's data in order to provide a simple system that is easy to use and avoids the problems associated with a full EPR. Thus, a VPR is not an EPR, which EPR replaces the hard copy patient records. The VPR merely augments the HCPR.

It should also be mentioned that the novel method according to the present invention focuses on the use and exchange of information and not on the information itself. The inventive method does not merely digitize everything in the patient record, i.e., it doesn't adopt a brute force approach to the patient records problem. Moreover, the method according to the present invention generally does not require duplicate manual entry of data into both the VPR and the HCPR. The inventive method does automate the tasks involved with maintaining the Essential Information without interfering with normal clinical routine.

As illustrated in FIG. 1, a VPR 10 resides as a collection of electronic records 2 on a computer 1 in the healthcare provider's office. It should be mentioned that a recording medium 3 in the computer 1 stores both the electronic records 2 and instructions for instantiating the CR system (software). It will be appreciated that HCPR 20 is also stored in the healthcare provider's office. The operating methodology (rules) outlined above link the VPR 10 and the HCPR 20 into a so-called hyper-record.

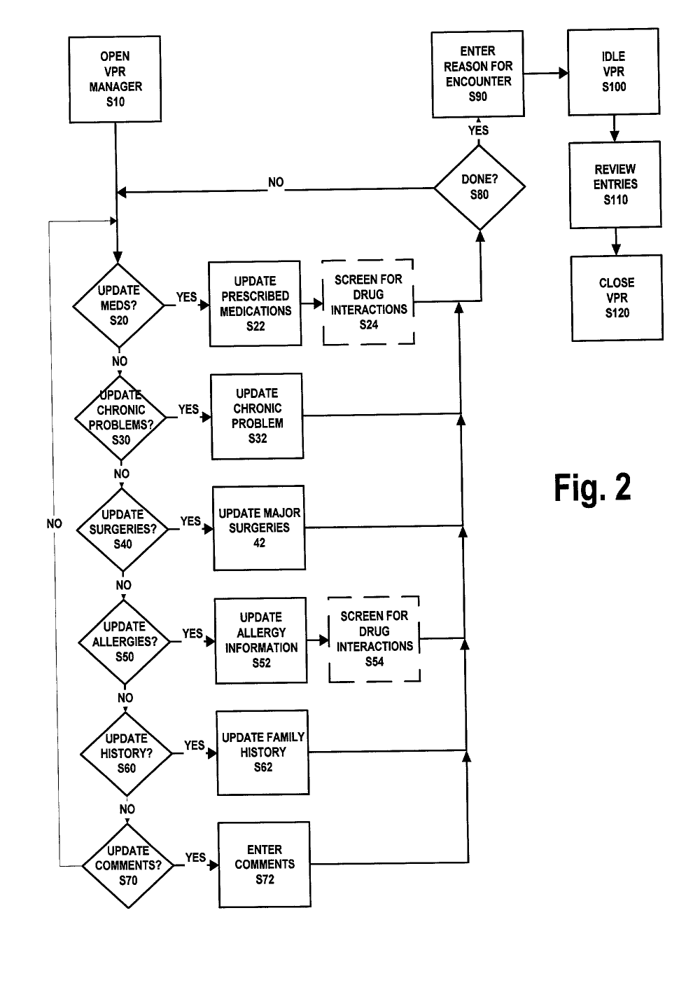

The method for creating and maintaining the VPR 10 according to the present invention will now be described while referring to FIGS. 2 through 13. In particular, FIG. 2 illustrates a flowchart for operating the CR System (software), i.e., the tool by which the VPR 10 is accessed and updated.

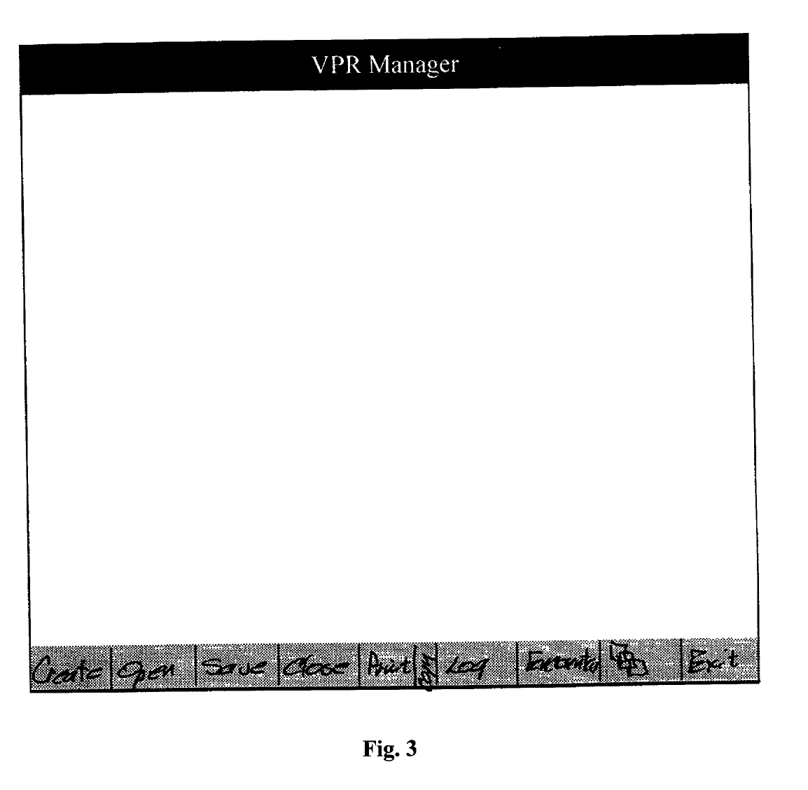

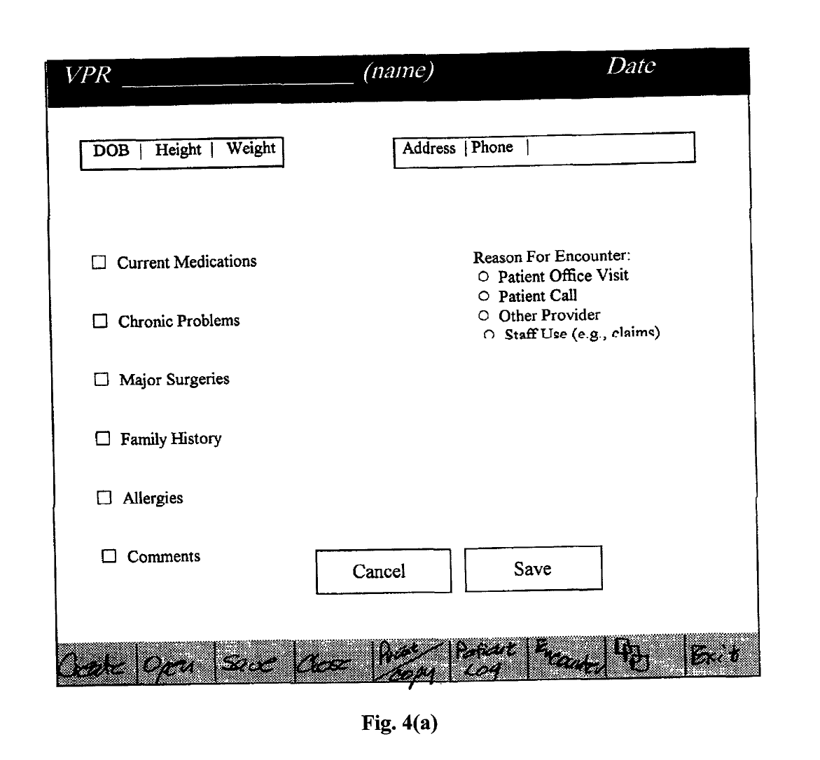

During step S10, the user in the healthcare provider's office, i.e., either the physician or his/her staff, instantiate the CR System, which generates a main screen simulated in FIG. 3. This is the main screen for the CR Application. Each patient has a VPR 10 computer file, which VPR contains all the essential patient information. The CR software VPR Manager Screen allows the user to create a new VPR, print a VPR, open an existing VPR, close an opened VPR, save a VPR, archive selected VPRs, and copy VPRs to another storage medium. It should be noted that multiple VPRs can be opened at any given time. In an exemplary case, the user will either create a new VPR or open an existing VPR when the CR system is initiated. FIGS. 4(a) and 4(b) illustrate are simulated screen captures of the new VPR or existing VPR, respectively.

After creating or selecting the VPR 10 to be updated, the user selects an area of the VPR 10 that needs to be updated. The CR software repeatedly performs a series of checks to determine which portion of the VPR 10 is to be modified. For example, the CR software checks whether the medication information is being updated at step S20. If the answer is negative, the CR software program jumps to step S30, during which a check is performed to determine whether data on the patient's chronic problems is to be updated. If the answer is again negative, the CR software program jumps to step S40, during which a check is performed to determine whether data on the patient's major surgeries is to be updated. If the answer is still negative, the CR software program jumps to step S50, during which a check is performed to determine whether data on the patient's allergies is to be updated. If the answer is negative, the CR software program jumps to step S60, during which a check is performed to determine whether data on the patient's family history problems is to be updated. If the answer is still negative, the CR software program jumps to step S70, during which a check is performed to determine whether general data, e.g., comments, on the patient is to be updated. If the answer at step S70 is negative, the series of checks, i.e., steps S20, S30, S40, S50, S60 and S70, are repeated until an affirmative answer is received.

It should be mentioned at this point that there are several ways to exit the CR software, such as simply hitting the “escape” key. However, since these are features common to most programs and, thus, familiar to the majority of users, additional details regarding CR software incidental features will not be described unless a specific feature is necessary to understanding the present invention.

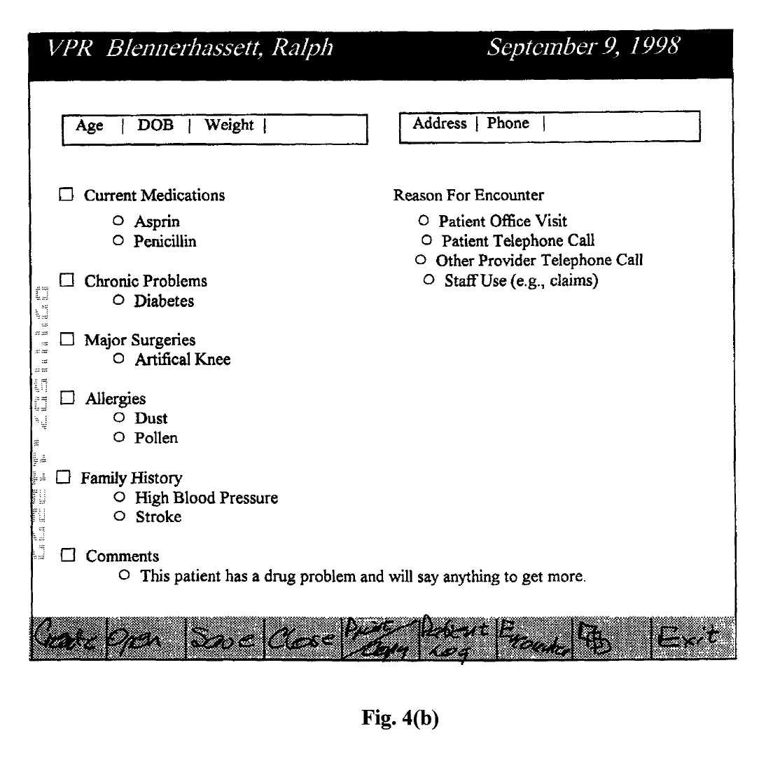

If the answer at step S20 is affirmative, step S22 is performed to create the Current Medication Update Screen, which is simulated in FIG. 5. The Current Medications Update Screen is used to add and/or delete information to the patient's VPR regarding the patient's current medications. It will be noted that the patient's name and current date appear automatically on this screen. It will be appreciated that this information is accessed by double clicking the square box in the VPR next to “Current Medications,” which is the equivalent to step S20 in FIG. 2. The update screen then appears, advantageously layered over the patient's VPR screen.

It should be mentioned that the update screen is divided into two sections. The first section lists the medications that currently appear on the patient's VPR. The second section allows medications to be added to the list. There are two alternative ways to enter the new medication information, both of which are illustrated in FIG. 5. First, the medication information can simply be typed in directly to the Medication Box. Second, the CR software includes a directory of commonly prescribed medications, which permits the user to simply scroll through this list to locate the prescribed medication. Double clicking on the selected medication causes the selected medication to appear in the Medication Box. Advantageously, the list of medications can be generated by a link to the Physician's Desk Reference (PDR). It will also be appreciated that additional information such as length of use, date of issue, issued by whom, etc., advantageously can be added by the user. In addition, is will be appreciated that when using an existing patient VPR, existing medication can be removed by the user by selecting the unused medication and then hitting the “delete” key.

When the information regarding currently prescribed medications has been completely entered, the user adds the medication information to the patient's VPR by clicking the “ADD” screen button. Subsequently double clicking on the “OK” screen button returns the user to the patient's VPR. It will be noted that use of the “OK” button prior to activation of the “ADD” button returns the user to the VPR without updating the current medication information.

During optional step S26, the contents of the current medication portion of the VPR can be input to Drug Interaction Software so that, as soon as a drug is added to the VPR, the Interaction software automatically alerts the provider if there is a conflict. It will be appreciated that this method of checking for drug interactions is much better then using the Drug Interaction Software alone because the VPR contains both the list of current medications and the newly prescribed medication. It will also be appreciated that this is more effect than Drug Interaction Software at the pharmacy, since the patient may frequent several pharmacies in his/her area.

After completing one of steps S22 and S24, a check is then performed to determine whether the necessary update of the patient's VPR has been completed. When the answer is negative, steps S20, S30, S40, S50, S60, and S70 are repeated until another area of the VPR is designated for updating. When, the answer is affirmative, the CR system confirms that the reason for the encounter has been recorder by the user, i.e., the user is returned to or remains in the VPR Manager screen of FIG. 3 until the reason for the encounter is entered by the user during step S90. It will be noted that the term “encounter” refers to any time the VPR has to be opened. Before the VPR can be closed, the “Reason for the Encounter” has to be checked off. If it isn't, the operator is notified when the user clicks the “Close” icon on the VPR Manager screen. It will be appreciated that the Reason for Encounter can be completed at any time when the VPR is open. If the Reason for Encounter has been filled in prior to attempting to exit the VPR, the CR software advances to step S100.

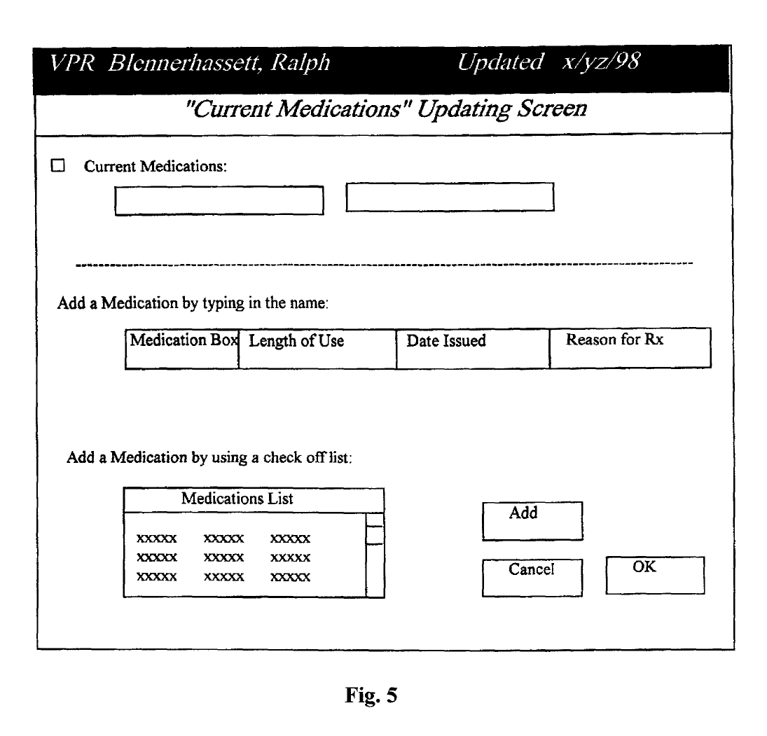

Assuming for the moment that the user only desires to update the current medication section of the VPR, the CR software marks the VPR as updated but idle during step S100. It will be appreciated from the discussion above that the CR software advantageously can include a two-party check function whereby one user enters data and a second user, e.g., the physician, verifies the data during step S110 and enters the necessary code word to close the VPR during step S120. It will also be noted that this facilitates efficient operation of the healthcare providers office, since the physician can look down the VPR Encounter Log, illustrated in FIG. 6, and return all of the patient calls during slack periods in the physicians schedule. Moreover, the physician can confirm that all calls have been returned, since only those qualified to return patient calls will have the proper code for closing the VPR. Of course, since the physician is in control of the CR system and the VPR's created thereby, the physician may elect, by setting the CR software preferences, to consolidate steps S100, S110 and S120 so that the physician or trusted staff member can close the VPR in a single step.

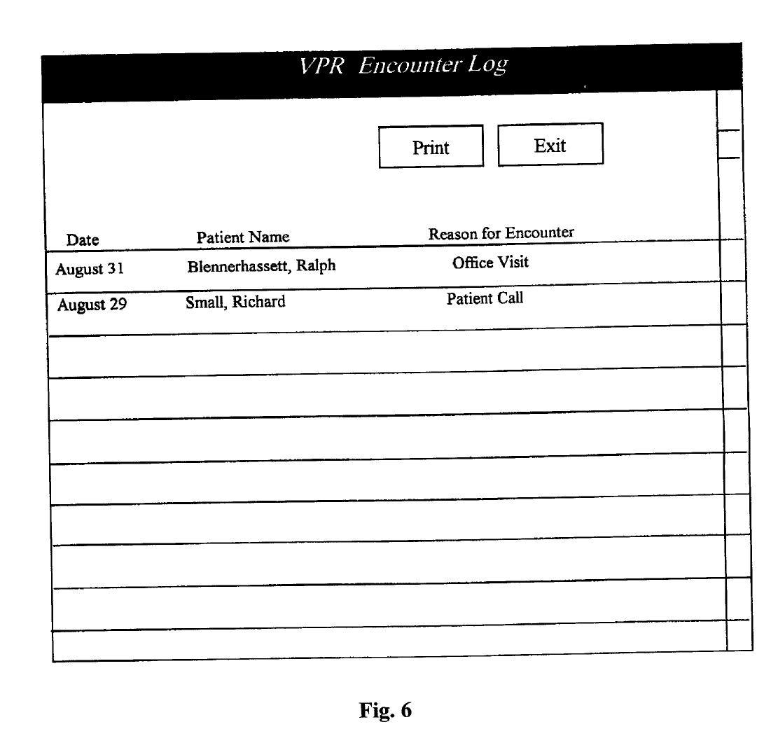

During step S32, information regarding chronic problems is updated via the screen illustrated in FIG. 7. The “Chronic Problems” Update Screen is accessed by double clicking on the box next to “Chronic Problems” in the patient's VPR (FIG. 3). As discussed above with respect to the current medication update screen, the screen illustrated in FIG. 7 will also be layered over the VPR screen. Again, the screen is divided into two sections. The first lists any current problems as they appear in the patient's VPR. The second one contains a “Chronic Problems Box.” This allows the provider to type in particular problems. The user advantageously can also check off ones from a list of common ailments listed just below the data entry box. When one of these common chronic problems is checked off, the selected chronic problem appears in the “Chronic Problems Box.” Moreover, as previously noted, it is possible to delete a chronic problem from the list by selecting the problem and the hitting the “delete” key. Clicking the “ADD” button will added the noted problems into the first section and into the patient's VPR. The CR program then steps to step S80 to determine whether the update of the patient's VPR has been completed, as discussed above.

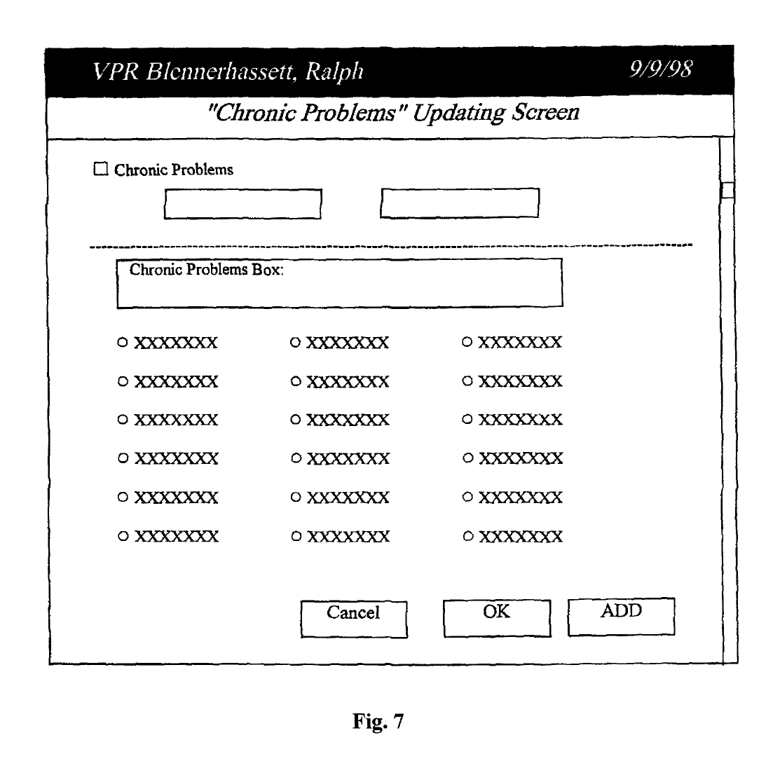

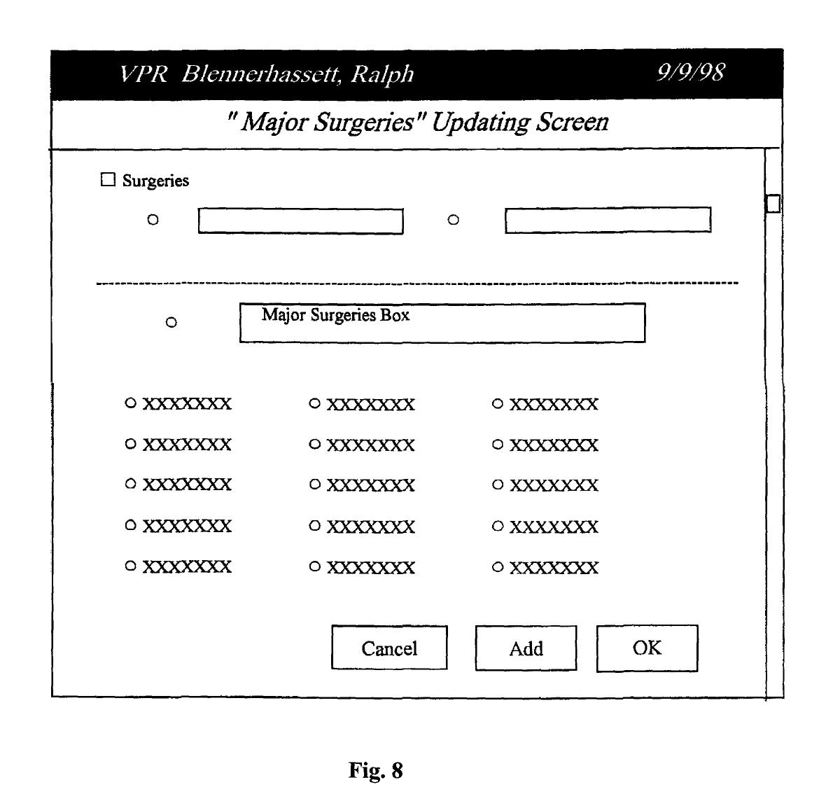

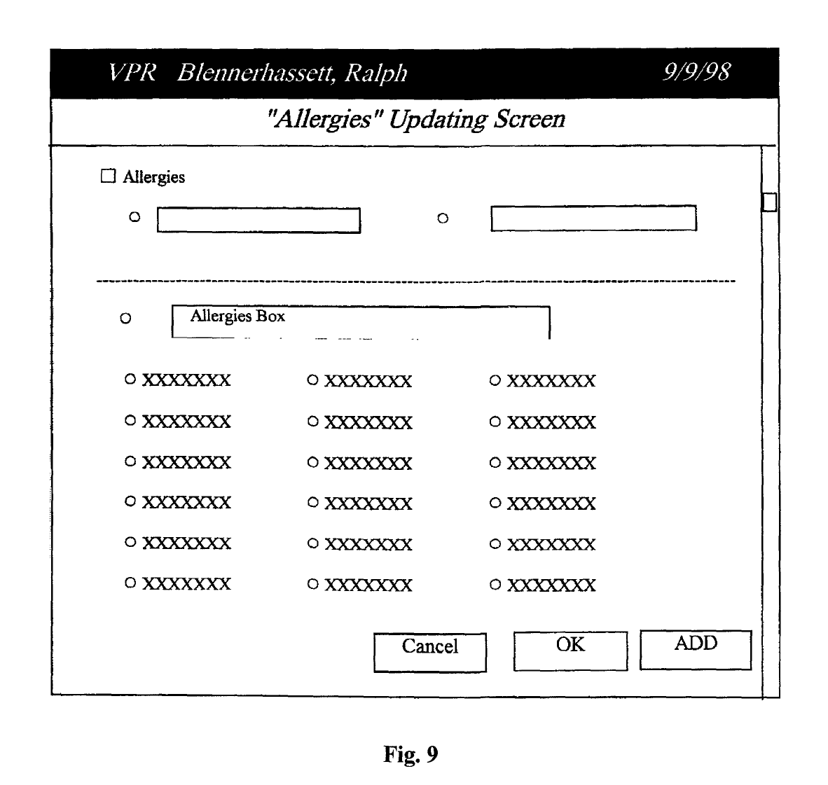

During step S42, the user displays the Major Surgeries Update Screen, as illustrated in FIG. 8. During step S52, the user displays the Allergies Update Screen, as illustrated in FIG. 9. Moreover, during step S62, the user displays the Family History Update Screen, as illustrated in FIG. 10. It will be appreciated that each of these screens permits the entry of the designated information into the patient's VPR. It should be mentioned that closing the Allergies Update Screen optionally can invoke the above mentioned Drug Interaction Software, to thereby ensure that the currently prescribed medications is not contraindicated for that particular patient.

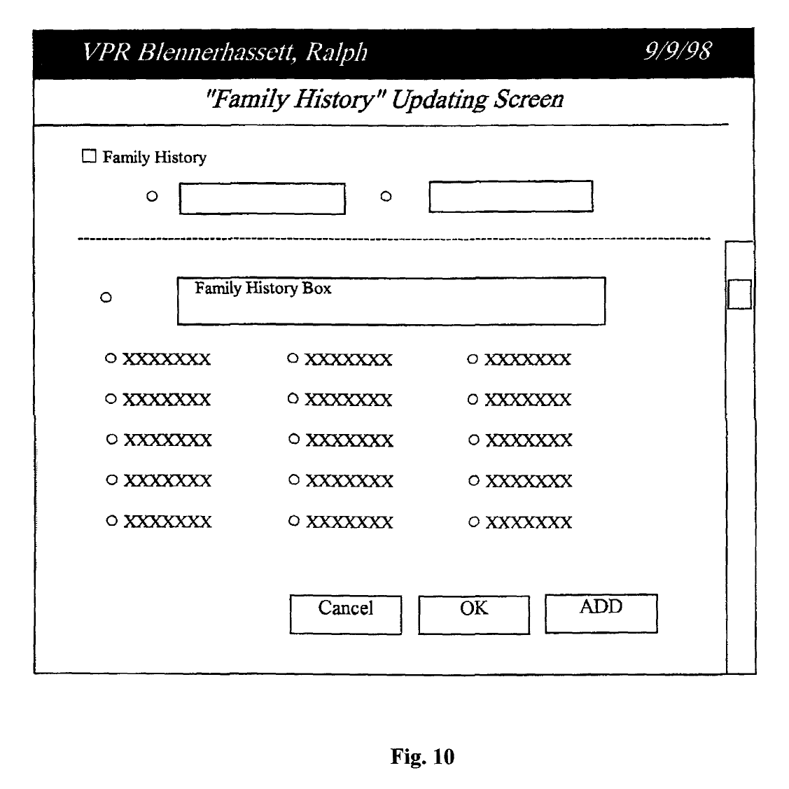

During step S72, the Comments Update Screen illustrated in FIG. 11 is displayed. It will be appreciated that the purpose of this screen is to allow for the addition of short, simple statements to the VPR. The Comment Update Screen is basically used to include information that doesn't fit into any of the other categories. This is specifically meant for essential information, not random notes. From an inspection of FIG. 11, it will be appreciated that the Comment Update Screen is divided into two parts. The first part lists the comments as they currently appear in the patient's VPR. The second section allows the provider to add comments. To add a comment, the provider types into the space provided. He/she then clicks the “ADD” button. It will be appreciated that common word processor icons for cut, paste, spelling, etc. are included and operative in the Comment Update Screen. It will also be appreciated that, in order to delete a comment, the provider clicks on the comment in the first section and then hits the “delete” button. Optionally, this section of the VPR can be password protected, if the healthcare provider wants to ensure that only selected members of the staff can view the comments in the VPR. It will be noted that such measures would not prevent a user, the physician's nurse from recording comments needed by the physician during a follow-up phone call; password protection would merely protect the information in the patient's VPR from user lacking a real need for this information.

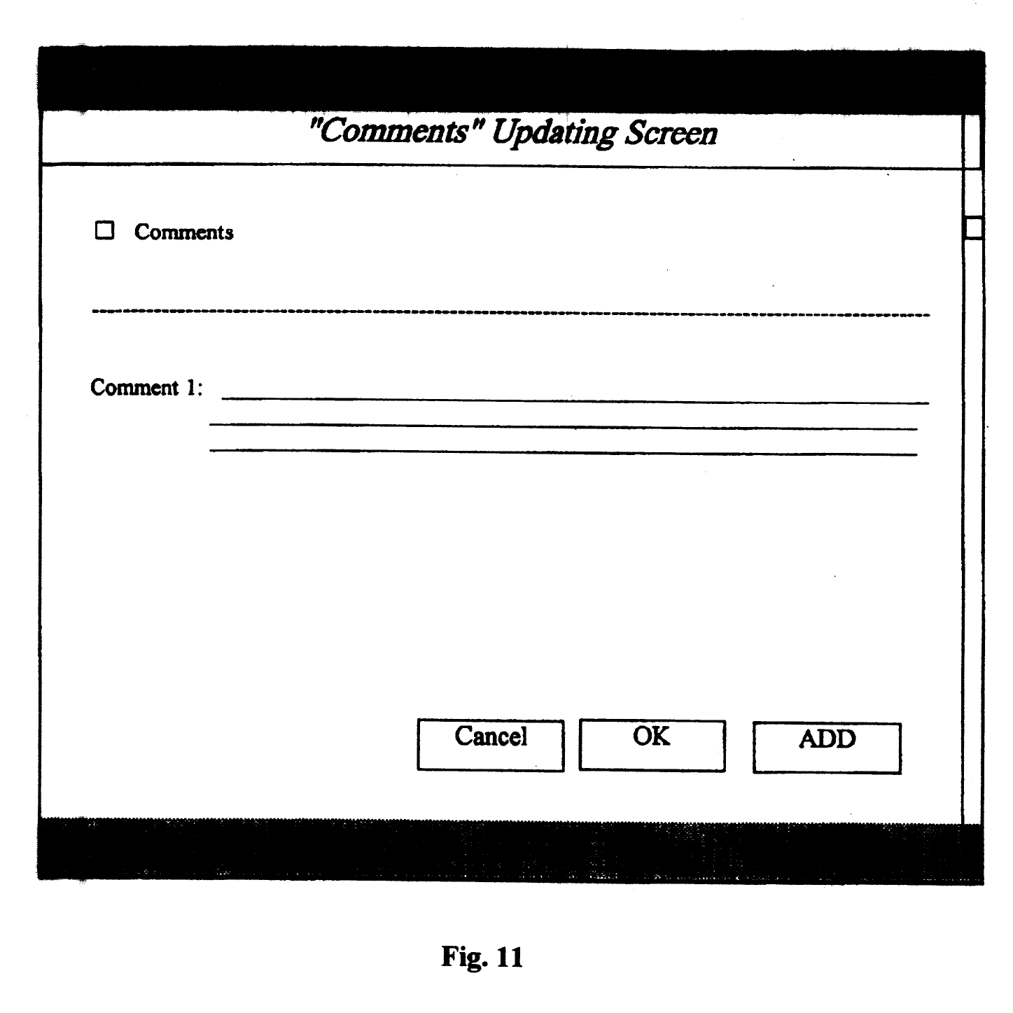

FIG. 12 illustrates a simulated screen capture of a VPR Directory, which can be accessed by clicking the Open File icon in the VPR Main Screen illustrated in FIG. 3. This screen gives two methods to open a patient VPR. Either the patient's name can be typed in or the user can scroll to the desired name. In either case, once the name has been highlighted, clicking OK will open the selected VPR. It will be appreciated that the data entry portion of the VPR Directory advantageously can be associated with a data sort function so that, as soon as the first letter of the last name is typed in, the scroll bar moves down to those names that start with this letter in the directory. It will also be appreciated that double clicking on the patient's name in the VPR directory opens that patient's VPR. A box in the existing VPR (see FIG. 4(b)) tells the provider the last time the VPR was updated, i.e., when there were changes made to the VPR. This screen now gives the provider vital patient information organized for quick retrieval. Then, by using the exact same procedures as for creating a patient record, the provider can update the record.

As previously mentioned, the CR software maintains an Encounter Log, as illustrated in FIG. 6. Clicking the “Encounter” icon in the VPR Main Screen (FIG. 3) opens the VPR Encounter Log. This screen gives a chronological listing of all VPRs that have been opened in reverse chronological order, i.e., most recent at the top of the screen. It will be appreciated that the VPR Encounter Log advantageously can be programmed to display a range of dates, either today's VPR actively or several months worth of VPR activity, or any range in between. Regardless of the number of days actually displayed, the VPR Encounter Log is designed to hold several months worth of encounters, e.g., log entries on 2,000 VPRs. Any selected portion of the VPR Encounter Log advantageously can be printed or copied to a permanent archive. It will be appreciated from FIG. 6 that the VPR Encounter Log lists all of the times a VPR was opened to deal with the need for essential patient information, i.e., the HCPR was not pulled; thus, the VPR Encounter Log will automatically show the savings afforded by use of the CR System.

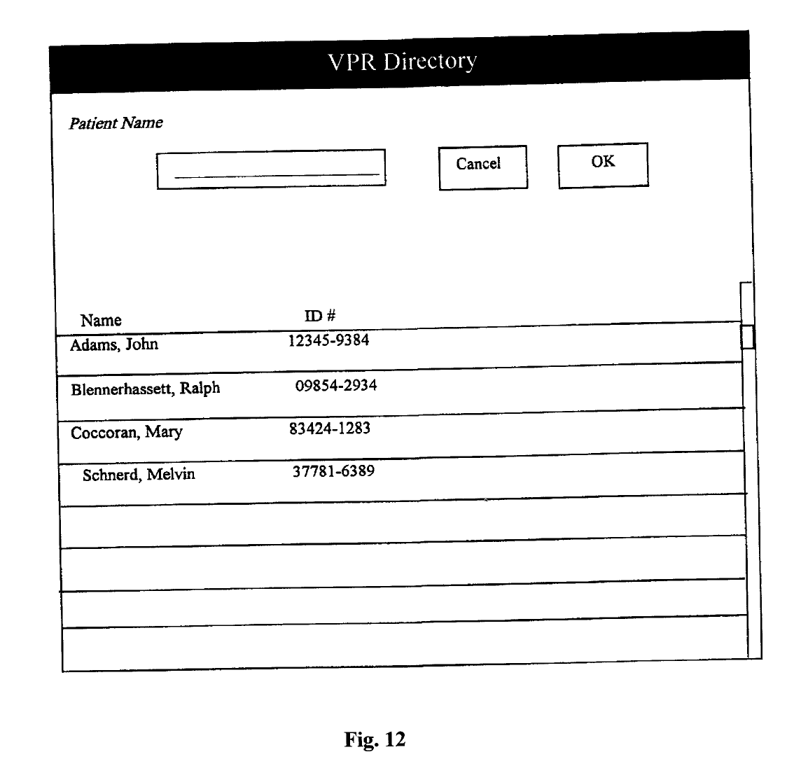

It should also be mentioned that double clicking on the desired patient's name in the Patient Log screen brings up the VPR Patient Log (FIG. 13) for that particular patient. That is, this screen shows every time the patient's VPR has been opened and why it was opened.

From the discussion above, it will be appreciated that there are basically two scenarios under which the patient's record is used for obtaining clinical information. The first is an office visit, which requires that the full HCPR be available to the physician. The second is the phone call. It will be noted that it has been estimated that only 10% of the phone calls received by the physician require the full HCPR. For example, when a specialist calls a primary care physician and needs to confer about a particular problem, the HCPR would be retrieved from the file room. However, the other 90% of the time, phone calls can be fielded by the physician having access to only Essential Information, i.e., the VPR. For example, when a specialist calls because he/she wants to prescribe a particular medication and wants to make sure that he/she isn't prescribing something that would be in conflict with a currently taken medication. This only requires the VPR and not the entire record.

Moreover, it will be appreciated that the VPR and the HCPR are not dual systems. Rather they work together to form a more efficient version of an overall patient record, one that requires no changes in the clinical routine of the provider and yet offers many of the benefits of the full EPR without the drawbacks. Thus, the VPR replaces the HCPR only when the essential information is all the information that is needed. Several examples of the use of the VPR in a clinical environment are provided immediately below.

In a first example, a patient comes in for an office visit. The staff accesses the patient's VPR and prints it out, retrieves the HCPR, and then affixes the VPR to the top of the HCPR. On opening the HCPR, the provider is trained to look for the VPR with that day's date on it. He/she then exams the patient and makes additions to the hardcopy record. Preferably, he/she makes changes in Essential Information directly onto the printout of the VPR. When the file goes back to the staff, they look at it for claims information, etc. They then make sure that any changes to the Essential Information, such as prescriptions for new medications, are made in the digital VPR. It should be noted that the provider is free to make changes to essential information directly into the VPR computer file himself. While this would eliminate the need for the physician's staff to enter VPR changes, this would also eliminate the two party check, since the physician can close the VPR. It should again be noted that the VPR is set up so that the reason for the encounter will have to be entered before the VPR can be closed. This helps maintain the documentation for E & M.

When a call comes in from a specialist, the first thing that happens is that one of the provider's staff accesses the patient's VPR on the computer. The specialist will almost always tell the staff that he/she needs to talk to the Primary Care Physician directly. This will almost always result in the HCPR being retrieved from storage. Consistent with the Rules established above, the VPR will be printed out and added to the top of the HCPR. During the subsequent conversation between the Primary Care Physician and the specialist, the Primary Care Physician may decide that notations be made in the hardcopy. Preferably, he/she will make changes in essential information directly onto the printout of the VPR. When the file goes back to the staff, they again read it and make any changes to the VPR that are necessary. It will again be noted that the VPR is set up so that the reason for the encounter will have to be entered before the VPR can be closed.

Most calls to the primary care physician are only asking for essential patient information, i.e., a specialist's staff asking for a list of current medications. When this happens, the Primary Care Physician's staff just accesses the VPR on a computer monitor, confident that all information on current medications has been kept current. The staff member can then read off the medications or fax this information to the specialist's office. The staff is also in a good position to make the additions to the essential information directly through the VPR. It should be mentioned at this point that, in the past, when only the hardcopy was available there were times when the doctor or the staff would get this information and then not update the hardcopy record because it was inconvenient to do so. Therefore, the VPR is a means of encouraging healthcare providers to maintain their patient's records more accurately because it is easier to do so.

In the exemplary case, the patient has had several calls to the primary care physician and changes have been made in the patient's VPR. When the patient then comes in for another visit, all that has to happen to update the hardcopy patient record is just print out the VPR. This works because the VPR has been kept current all the time.

The VPR is still useable by the Primary Care Physician when he/she is away from the office. For example. Each day upon leaving the office, the primary care physician can have the entire set of VPR's copied to some portable medium. For example, the hard drive of a laptop, hard floppies, etc. He/she now has access to the VPR's of all his/her patients no matter where he/she is. When calls come in at night, the physician does not have to rely on memory or the patient for Essential Information. It will be appreciated that this alone should improve healthcare and relieve the provider of a great deal of stress and frustration.

It will be noted that it would also be possible to permit the Emergency Room to access the VPRs. All primary care physicians are associated with hospitals. On a regular basis, the provider could transfer all his VPR files to a computer at each hospital where the physician has privileges. The hospital would then have the VPRs for a large percentage of the Emergency Room patients that the hospital is likely to see.

Finally, it should be noted that the physician advantageously could obtain the VPR(s) needed via remote access. First, the needed VPR's could simply be sent via email or downloaded from a secure site at the healthcare provider's office. Alternatively, assuming that privacy considerations have been overcome, a database with patient VPR's could be established that would totally eliminate the need for many of the calls from specialists that a provider's office receives every day. Basically, using security codes and the permission of the patient, the specialist could access the patient's VPR and get the information he/she needs.

It will be appreciated that the CR software and operating method according to the present invention improves healthcare delivery while reducing the costs associated with healthcare delivery. The VPR provides a digital patient record that addresses the 60% of the uses where only 5% of the information is needed, i.e., when only the Essential Information is needed. Moreover, the CR system improves the accuracy of patient records by making them easier to access and update. Moreover, the CR system provides a method by which the updating of the patient record is very fast. Stated another way, the CR system creates a digital system that retrieves patient information quickly, i.e., improve the access speed.

It will also be appreciated that the VPR and associated CR system decreases the cost to access patient information by going to a digital system and, thus, eliminating, to the maximum extent possible, the need to retrieve the HCPR. It will be understood that the inventive method and corresponding software provides a system that is digital and, yet, does not require the physician to change his/her normal clinical routine. It will also be understood that the CR system creates a digital system that is inexpensive, easy to learn, easy to use, and yet is effective. Moreover, the method according to the present invention provides a CR system that reduces labor intensive tasks involved in accessing patient records.

Another aspect of the method and corresponding software according to the present invention is that it creates an operating method that takes advantage of the digital patient record and computers to aid in meeting government regulations for documentation of Evaluation and Management. For example, the inventive method automatically establishes a provider profile when implemented. Moreover, the inventive method also reduces the stress and frustration felt by providers by giving them a means to access essential patient information at all times, even when they are not in their office. Furthermore, it provides hospitals associated with the primary care physician a means by which to access Essential Patient information.

Thus, the present invention has been described herein with reference to a particular embodiment for a particular application. Those having ordinary skill in the art and access to the present teachings will recognize additional modifications applications and embodiments within the scope thereof.

It is therefore intended by the appended claims to cover any and all such applications, modifications and embodiments within the scope of the present invention.

What is claimed is:

1. A patient record comprising:
a digital vital patient record (VPR) storing essential predetermined information for a patient; and
a hardcopy patient record (HCPR) storing routine information and essential information,
wherein the information in the VPR takes precedence over corresponding information in the HCPR.

2. The patient record as recited in claim 1, wherein:
the HCPR is stored in a designated storage area; and
a printout of the VPR is added to the HCPR each time the HCPR is retrieved from the storage area.

3. The patient record as recited in claim 1, wherein:
the HCPR is stored in a designated storage area; and
a printout of the VPR corresponds to a request to retrieve the HCPR from the storage area.

4. A method of maintaining vital patient information complementing a hardcopy patient record (HCPR) maintained at a healthcare provider's office, comprising:
generating a digital vital patient record (VPR) corresponding to a patient;
updating predetermined information in at least one of N categories in the VPR;
opening the VPR whenever the patient interacts with the healthcare provider's office; and
inserting a printed copy of the VPR whenever the HCPR is accessed in the healthcare provider's office,
wherein N is an integer greater than 1.

5. The method as recited in claim 4, wherein one of said N categories comprises currently prescribed medications.

6. The method as recited in claim 5, further comprising the step of executing a drug interaction screening program using the predetermined information in the currently prescribed medications category.

7. The method as recited in claim 4, wherein one of said N categories comprises allergies.

8. The method as recited in claim 7, further comprising the step of executing a drug interaction screening program using the predetermined information in the allergies category.

9. The method as recited in claim 4, wherein:
the generating, updating, opening, and inserting steps are performed by a first user in the healthcare provider's office; and
the method further comprises the step of closing the VPR, said closing step being performed by a second user in the healthcare provider's office.

10. The method as recited in claim 4, wherein said opening step is performed by a first user in the healthcare provider's office; and
the method further comprises the step of closing the VPR, said closing step being performed by a second user in the healthcare provider's office.

11. A recording medium for storing a computer readable instructions for converting a general purpose computer into a core records system for maintaining vital patient information complementing a hardcopy patient record (HCPR) maintained at a healthcare provider's office, wherein the instructions permit the computer to generate a digital vital patient record (VPR) corresponding to a patient; to update predetermined information in at least one of N categories in the VPR; to open and update the VPR whenever the patient interacts with the healthcare provider's office; and to print a copy of the VPR for insertion into the HCPR whenever the HCPR is accessed in the healthcare provider's office, wherein N is an integer greater than 1.

12. The recording medium as recited in claim 11, wherein one of said categories comprises currently prescribed medications.

13. The recording medium as recited in claim 12, wherein the instructions further permit execution of a drug interaction screening program using the predetermined information in the currently prescribed medications category.

14. The recording medium as recited in claim 11, wherein the instructions permit a first user to generate, update, open, and print the VPR and permit a second user to close the VPR.

15. A computer program for converting a general purpose computer into a core records system for maintaining vital patient information complementing a hardcopy patient record (HCPR) maintained at a healthcare provider's office, wherein the instructions permit the computer to generate a digital vital patient record (VPR) corresponding to a patient; to update predetermined information in at least one of N categories in the VPR; to open and update the VPR whenever the patient interacts with the healthcare provider's office; and to print a copy of the VPR for insertion into the HCPR whenever the HCPR is accessed in the healthcare provider's office, wherein N is an integer greater than 1.

16. The computer program as recited in claim 15, wherein one of said categories comprises currently prescribed medications.

17. The computer program as recited in claim 16, wherein the computer program executes a drug interaction screening program using the predetermined information in the currently prescribed medications category.

18. The computer program as recited in claim 15, wherein the computer program permits a first user to generate, update, open, and print the VPR and permits a second user to close the VPR.
